(19) United States
(12) Patent Application Publication
(10) Pub. No.: US 2015/0077838 A1
(43) Pub. Date: Mar. 19, 2015

(54) Fresnel Rhomb

(71) Applicant: Leibniz - Institut für Analytische Wissenschaften - ISAS - e.V., Dortmund (DE)

(72) Inventors: Maciej Neumann, Berlin (DE); Eugen Speiser, Berlin (DE)

(21) Appl. No.: 14/450,021

(22) Filed: Aug. 1, 2014

(30) Foreign Application Priority Data
Aug. 2, 2013 (DE) 10 2013 108 321.8

(51) Int. Cl. G02B 5/30; G02B 1/08

(52) U.S. Cl. CPC G02B 5/3066; G02B 5/3091; G02B 1/08
USPC 359/352

(57) ABSTRACT

A Fresnel rhomb which can be used over a wide range of wavelengths, including wavelengths below 250 nm, takes into account the orientation of the crystal structure of the rhomb during manufacturing of the rhomb and adjusts the entrance side of the front end in relation to the direction-dependent birefringence. The beam incident on the Fresnel rhomb always forms a set angle of 90° with the front end in order to achieve the desired effect. If the orientation of the crystal structure is taken into account when the front end is manufactured and appropriately adjusted, the light beam will follow a given direction through the crystal. In such a way non-isotrop properties of the material can be considered and used for the desired application. One of such non-isotrop properties of the material is, for example, the direction-dependent birefringence when using CaF₂, BaF₂ or similar materials.

### TECHNICAL FIELD

The invention relates to a Fresnel rhomb. A Fresnel rhomb enables the conversion of linear polarized light to circular polarized light by double total reflection.

A Fresnel rhomb is a transparent body, such as made from glass, which has a cross section in the form of a rhomboid (parallelogram). The acute angle of the rhomb is selected such that linear polarized light which is incident on one of the front ends is totally reflected twice with such angle. The selection of the angle depends on the refractive index of the material used for the body at a selected wavelength. Optical crown glass (refractive index n=1.5), for example requires an angle of 54° 37′. The twice totally reflected light exits the body at the opposite back end in a perpendicular direction also. The ray is shifted by this procedure.

If the oscillation plane of the incident linear polarized light forms an angle of 45° with the reflection plane of the rhomb, circular polarized light is generated. A phase difference δ=π/4 is generated with each total reflection, i.e. δ=π/2 between the TE-component which is polarized perpendicular to the reflection plane and the TM-component which is polarized parallel to the reflection plane. The use of two suitable Fresnel rhombs will again provide linear polarized light without a shift.

The phase difference generated with a Fresnel rhomb has only a small dependence on the wavelength for large ranges. Accordingly, it is used for applications where only a small wavelength dependence is required.

### Prior Art

On the internet page

http:www.wmi.badw.de/teaching/Lecturenotes/Physik3/Gross_Physik_III_Kap_{—}3.pdf

Usually one or two Fresnel rhombs are used in order to achieve an overall delay of 45° or 90°, respectively.

Fresnel rhombs are sold on the internet page http:www.halbo.com/fr_rhumb.htm. A graphic representation of the dependence of the phase delay on the wavelength is given for CaF₂. The phase delay increases with decreasing wavelength. In known assemblies it is assumed that CaF₂ has no birefringent properties.

In the publication “Intrinsic birefringence in calcium fluoride and barium fluoride” in Physical Review B. Vol. 64, p 241102 (R) from 29 Nov. 2001 by John H. Burnett, Zachary H. Levine and Eric L. Shirley it is described that there is a small birefringence in CaF₂ and BaF₂ in wavelength ranges below 250 nm. It was found that the birefringence is dependent on the direction of the birefringence.

Such small birefringence may not be neglected if light with short wavelengths is used for long optical paths, such as they occur in Fresnel rhombs. Commercially available Fresnel rhombs are, therefore, not suitable for use with short wavelengths of light below 250 nm or can he used only in a limited way.

### DISCLOSURE OF THE INVENTION

It is an object of the invention to provide a Fresnel rhomb according to the above mentioned kind, which can be used in wide wavelength ranges even with light below 250 nm.

According to an aspect of the invention this object is achieved in that the orientation of the crystal structure is taken into account during manufacturing and adjusting of the entrance side of the front end in relation to the direction-dependent birefringence. The beam incident on the Fresnel rhomb always forms a set angle of 90° with the front end in order to achieve the desired effect. If the orientation of the crystal structure is taken into account when the front end is manufactured and adjusted the light beam will follow a given direction through the crystal. In such a way non-isotrop properties of the material can he considered and used for the application. One of such non-isotrop properties of the material is, for example, the direction-dependent birefringence when using CaF₂, BaF₂ or similar materials.

Especially with short wavelengths there are several different phase-influencing effects in some materials, such as CaF₂ or BaF₂, used for a Fresnel rhomb. The light beam travels in a first direction perpendicular to the front end along a first portion of the path. A first phase delay occurs depending on the direction and the length of the path due to birefringence. A further phase delay is effected by total reflection. After total reflection the light beam travels in a second direction along a second portion of the path. A third phase delay is caused by birefringence which also depends on the direction and the length of the path in such second direction. The second total reflection also causes a phase delay. After the second total reflection the light beam travels along a third portion of the path in the first direction. The entire length of the path in the first direction, therefore, corresponds to the sum of the first and the third portion of the path. The length of the path in the second direction corresponds to the second portion of the path.

In many materials the delay values for birefringence assume positive values in some directions and negative values in other directions. In other words: the parallely polarized component of the light is faster than the perpendicularly polarized component in some directions and slower in other directions. Therefore, it is provided by a preferred modification of the invention that the birefringence in the first travelling direction of the light, the birefringence in the second travelling direction (B) of the light and the delays caused by total reflections are optimized to a selected delay value.

Such an optimization can be achieved in particular by minimizing the deviation of the desired overall delay for all wavelengths of a selected wavelength range.

Preferably, the rhomb according to the present invention consists of CaF₂ or BaF₂, The material is transparent even for short wavelengths from a wavelength range below 250 nm and it is very suitable for the use in ellipsometry or other measuring applications requiring the control of the polarization.

Further modifications of the present invention are subject matter of the subclaims, An embodiment is described below in greater detail with reference to the accompanying drawings.

### BRIEF DESCRIPTION OF THE DRAWINGS

FIG. 1 shows a cross section of a typical Fresnel rhomb and the corresponding light path.

FIG. 2 illustrates typical designations and geometric conditions in a crystal structure.

FIG. 3 shows the dependence of the phase delay on the wavelength from an experiment for known assemblies and theoretical values for assemblies where the direction of the front end was optimized.

FIG. 4 illustrates the dependence of the delay per mm of material on the direction of the light beam where two directions with fixed distance are marked where the phase delays are compensated along the entire optical travelling path in the Fresnel rhomb.

FIG. 5 is a cross section of two consecutive Fresnel rhombs.

### DESCRIPTION OF THE EMBODIMENT

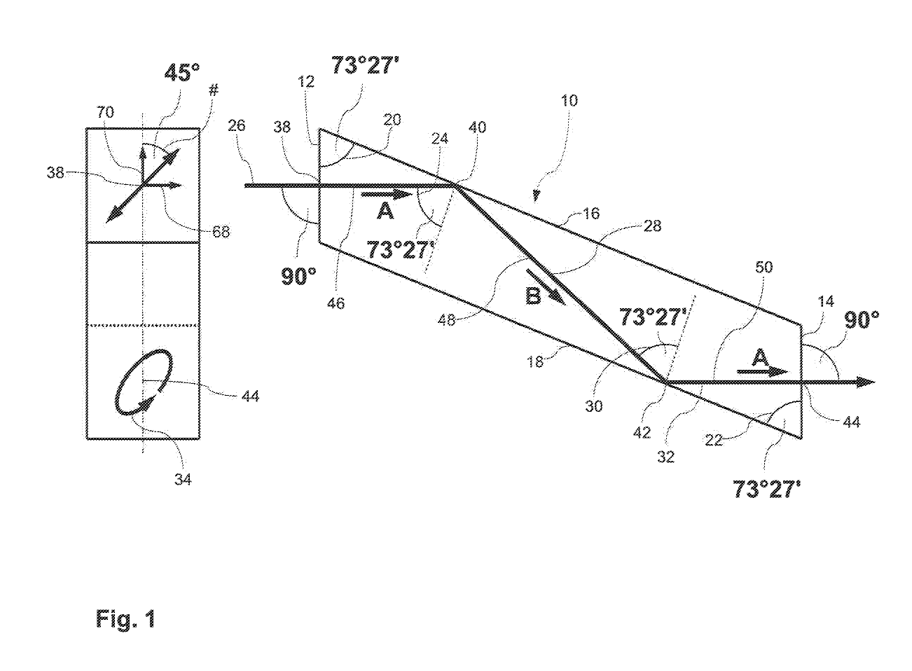

A typical Fresnel rhomb is shown in FIG. 1 which is generally designated by numeral 10. In the present embodiment the material is a calcium fluoride (CaF₂) crystal. It is understood, however, that the selection of the material depends on the application and the wavelength range which is used and different materials with corresponding properties may be used for different applications.

A cross section of the rhomb 10 is shown in FIG. 1, the cross section being the same along its entire width. The rhomb 10 has an entrance side front end 12 and an exit side back end 14. The front end 12 and the back end 14 are parallel planes. The material between the front and back ends is limited by four side faces with each two opposite side faces being parallel, respectively. Two of the side faces, namely side faces 16 and 18, extend perpendicular to the representation plane. The side faces which are parallel to the representation plane can not be seen in this representation. The front and back ends 12 and 14 form an acute angle 20 and 22 which is in the present embodiment φ=73° 27′. In such a way a rhomb is formed in the shown manner.

A beam 26 entering perpendicularly at the front end 12 is incident on the side face 16 at an angle 24 which corresponds to the angle φ with such a geometry. Due to the selected material the beam is totally reflected. The totally reflected beam 28 is incident on the side face 18 at the angle designated with numeral 30. Since side faces 16 and 18 are parallel, the angle 30 is the same as angle φ. The beam is again totally reflected. The twice totally reflected beam 32 exits the rhomb at an angle of 90° at the exit side back end 14.

A polarization dependent delay occurs with each total reflection at the side faces 16 and 18. This effect is well known and can be derived from the Fresnel equations. If the incident light, i.e. beam 26, is linear polarized with an angle of 45°, the TM-component, which is polarized parallel to the reflection plane, is delayed by 22.5° regarding the TE-component, which is perpendicularly polarized with each total reflection. In the present assembly the overall delay is 45°. If the intensities of the components of the incident beam 26 are the same in both polarization directions the exiting beam 32 is elliptically polarized. This is indicated by an ellipse 34.

The above explanations of a Fresnel rhomb assume entirely isotrope material. This, however, is not the case for small wavelengths below 250 nm. The direction dependency of the delay especially for small wavelengths will cause the polarization states of a beam to change in a different way than described above.

The beam 26 travels through a Fresnel rhomb along a first travelling path 46 in a first direction designated “A” between the point of entrance 38 at the front end 12 and the point 40 of the first total reflection. Furthermore, the beam 28 travels along a second travelling path 48 in a second direction designated “B” between the point 40 of the first total reflection and the point 42 of the second total reflection. Finally, the beam 32 travels along a third travelling path 50 again in the first direction designated “A” from the point 42 of the second total reflection to the exit point 44 at the back end 14. In other words: the delay is the sum of the delays along the sum of travelling paths 46 and 50 in the direction A and the delay along the travelling path in the direction B.

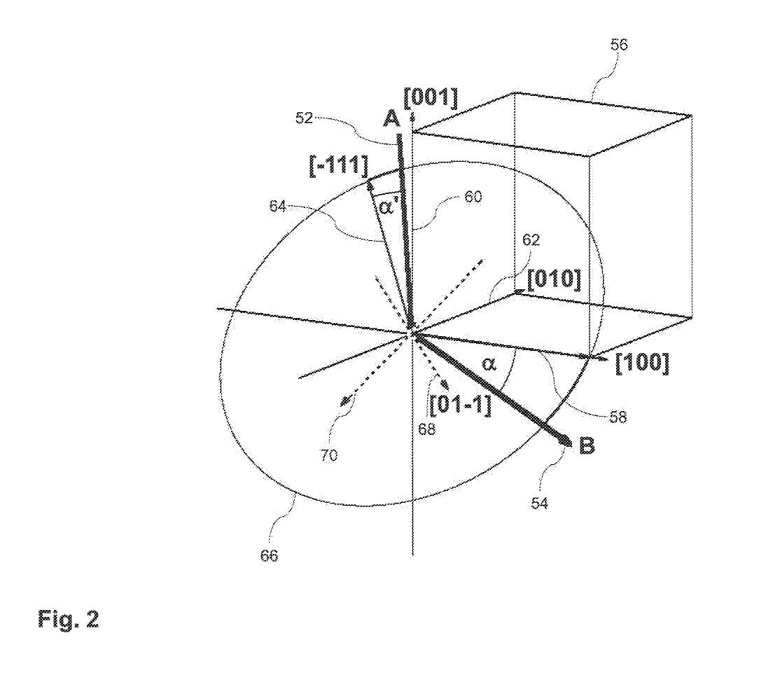

FIG. 2. illustrates the geometric conditions of the beam directions relatively to the crystal structure. Direction A is represented by a bold arrow 52. Direction B is represented by a bold arrow 54. The cuboid 56 represents the crystal structure. The crystal structure can be represented in known manner by principal directions. In the present embodiment the crystal structure has principal directions forming a Cartesian coordinate system. The crystallographic direction [100] is represented by an arrow 58. The crystallographic direction [001] is represented by an arrow 60. The crystallographic direction [010] is represented by an arrow 62. Such arrows correspond to the directions of the edges of the cuboid 56. The direction [−111] is represented by arrow 64. This direction extends along a diagonal of the adjacent cuboid which is not shown in the present representation in order to keep the representation simple.

Beam directions A and B are not parallel. The directions A and B define a plane. The plane was selected such that the directions [100] and [−111] also lay in this plane. The plane is represented by a circle 66. The beam direction B forms an angle α with the principal direction [100]. The beam direction A forms an angle α′ with the principal direction [−111]. In such a constellation the light beam 26 entering the rhomb has a TE-component in the direction [01-1] (dashed arrow) which is polarized perpendicularly to the reflection plane and designated with numeral 68 in FIG. 2 and a TM-component in the direction designated with numeral 70 (dashed arrow) which is polarized parallely to the reflection plane.

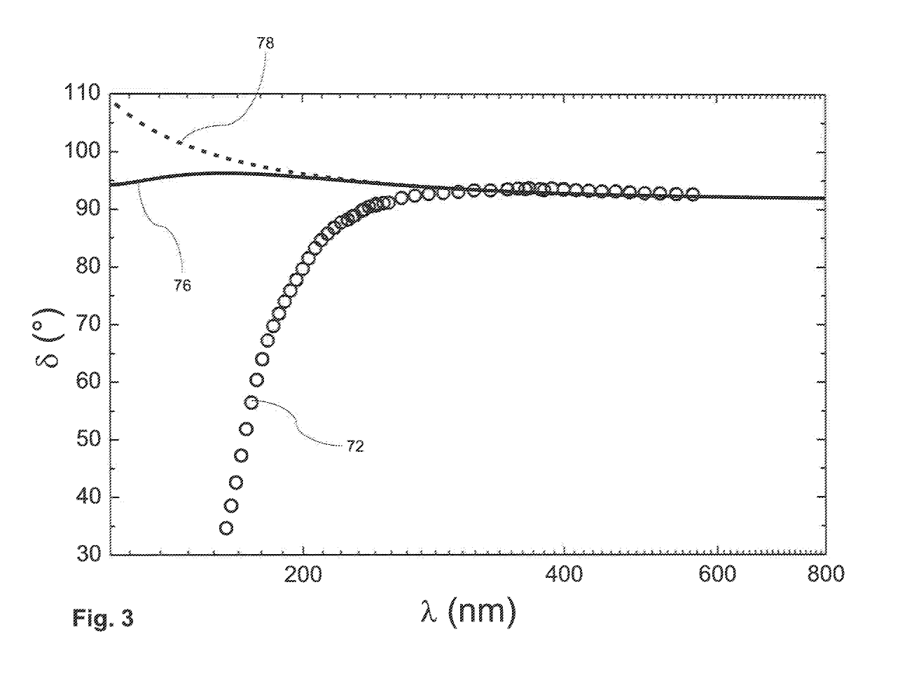

Additionally to the delay caused by total reflection, a weak direction dependent birefringence occurs in the crystal. It is particularly strong for small wavelengths below 250 nm and may not be neglected. FIG. 3 shows experimental results of the measurement of the phase delay δ for a commercially available Fresnel double rhomb made of a CaF₂ crystal as a function of the wavelength. The measuring points are designated with 72. It can be recognized that phase delays above 250 nm are in the range of 90° as described above for a single Fresnel rhomb with 45° phase delay. The phase delay δ strongly drops below 250 nm and is only about 40° at 170 nm.

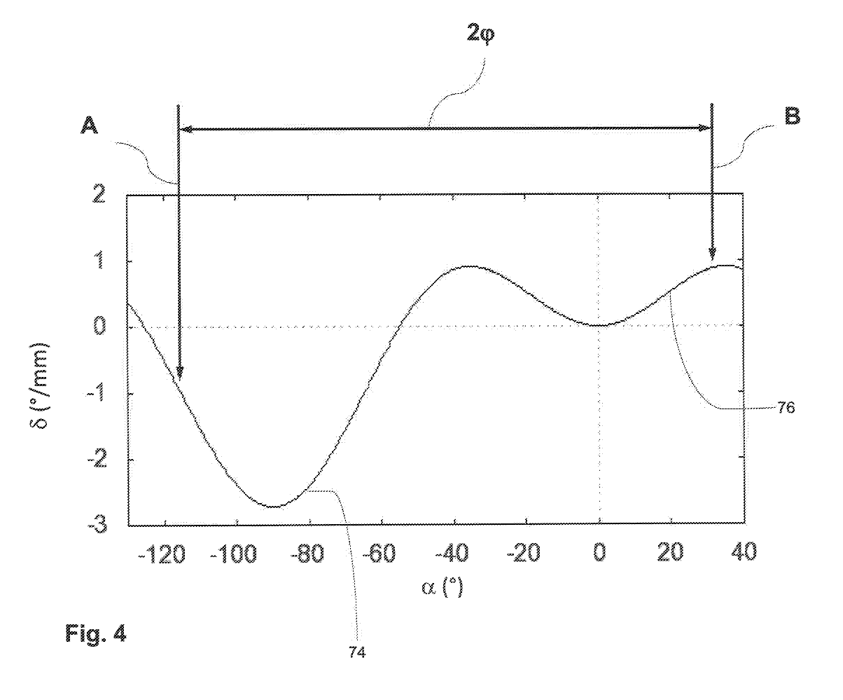

The effect depends on the direction. FIG. 4 shows the delay δ caused by the direction dependent birefringence per mm of material in the direction of various angles α, i.e. for different directions in the plane 66. In the representation α=0° corresponds to the principal direction [100] in FIG. 2.

Negative ranges, such as the range 74, are ranges where the refractive index for the perpendicularly polarized component 68 is smaller than for the parallely polarized component 70 and therefore causes a negative delay. In the positive range, such as range 76, the opposite applies. The refractive index for the perpendicularly polarized. component 68 (FIG. 2) is larger than for the parallel polarized component 70 thereby causing a positive delay.

In the present example the direction A is about −115°. It can be recognized that the beam in the direction A has a delay of δ≈−1°/mm. Direction B has, as can be derived from FIG. 1, a set angle which is shifted by 2*73° 27′ at about 30°. The beam in the direction B has a delay of about δ≈1°/mm. The angular difference 2*φ=2*73°27′ between direction A and direction B is set by the used material to achieve the properties of the Fresnel rhomb. The direction of the crystal, however, can be selected to achieve a value which is as suitable as possible. A change of the crystal direction corresponds to a shift of the two arrows A and B in FIG. 4 with identical distance.

A crystal direction can be found where the effects of birefringence in the direction A and birefringence in the direction B just compensate. In the selection shown in FIG. 4 the delay in the direction A is negative and in direction B it is positive. The optimum results are designated with numeral 76 in FIG. 3. it can be seen that by suitably adjusting the crystal in the right direction, i.e. by suitably selecting the direction of the front end 12 and the back end 14 relative to the crystal structure the wavelength dependency of the phase delay can be minimized. In the present embodiment the phase delay was optimized to a value of 90° for the entire wavelength range.

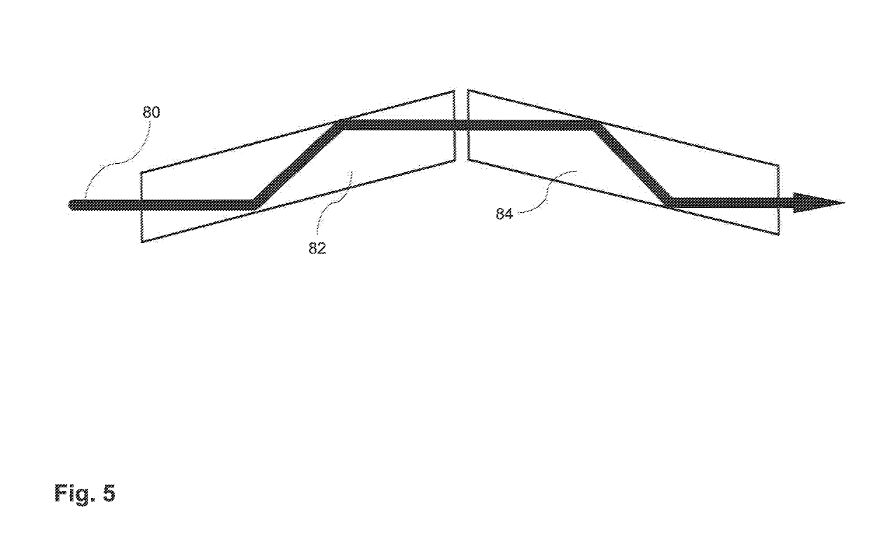

Depending on the application it can make sense to generate a phase delay without beam shift. For such an application two Fresnel rhombs are arranged in series. FIG. 5 illustrates how the beam 80 travels through two consecutive Fresnel rhombs 82 and 84. The direction of the polarized radiation is changed by 90° and the beam keeps its direction.

What is claimed is:

1. A Fresnel rhomb comprising
a plane front end and
a plane back end, the front end and the back end being parallel to each other, and
four plane side faces connecting said front end to said back end wherein each two opposite side faces are parallel to each other and two of said plane side faces being adapted to totally reflect light perpendicularly incident on said front end, whereby a delay is caused by said total reflection at said plane side faces,
said Fresnel rhomb consisting of a crystal material causing direction dependent birefringence in the wavelength range below 250 nm, said crystal having a crystal structure with an orientation relative to said front end and said back end,
and wherein
said orientation of said crystal structure is taken into account during manufacturing and adjusting of said front end in regard to said direction-dependent birefringence.

2. The Fresnel rhomb of claim 1, and wherein said orientation of said crystal structure is selected in such a way that said direction-dependent birefringence in a first travelling direction (A) of light, said direction-dependent birefringence in a second travelling direction (B) of light and delays caused by total reflection are optimised to a selected delay value.

3. The Fresnel rhomb of claim 2, and wherein said optimisation is effected by minimising the deviation of the desired overall delay for all wavelengths of a selected wavelength range.

4. The Fresnel rhomb of claim 1, and wherein said material is either CaF₂ or BaF₂.

5. An optical measuring assembly with polarization control comprising a Fresnel rhomb according to claim 1.

6. The Use of a Fresnel rhomb according to claim 1 for ellipsometry with wavelengths shorter than 250 nm.
